(19) United States
(12) Patent Application Publication
(10) Pub. No.: US 2026/0268571 A1
(43) Pub. Date: Sep. 10, 2026

(54) METHOD AND APPARATUS FOR PROVIDING A GUERRILLA PERFORMANCE EVENT IN A VIRTUAL SPACE

(71) Applicant: WEVERSE COMPANY INC., Seongnam-si (KR)

(72) Inventor: KIM Dong Hyun, Seongnam-si (KR)

(21) Appl. No.: 19/659,894

(22) Filed: Apr. 27, 2026

Related U.S. Application Data
(63) Continuation of application No. PCT/KR2024/016146, filed on Oct. 23, 2024.

(30) Foreign Application Priority Data
Oct. 27, 2023 (KR) 10-2023-0145681
Feb. 5, 2024 (KR) 10-2024-0017325

(51) Int. Cl. G06T 13/40; G06T 13/80

(52) U.S. Cl. CPC G06T 13/40; G06T 13/80

(57) ABSTRACT

A computer-implemented method and an apparatus generate a guerrilla performance event venue in a virtual space, determine whether a number of characters that have entered the venue equals or exceeds a predetermined target number of participants, and, when the guerrilla performance event starts, block entry of additional characters while providing a streaming video of a performance of an artist to the entered characters. The method and the apparatus may change a venue type or a character appearance based on music output, store action data of the characters, and generate a performance video of the guerrilla performance event.

### CROSS-REFERENCE TO RELATED APPLICATIONS

This application is a Continuation of Application No. PCT/KR2024/016146, filed on Oct. 23, 2024, which in turn claims the benefit of Korean Patent Applications No. 10-2023-0145681, filed on Oct. 27, 2023, and No. 10-2024-0017325, filed on Feb. 5, 2024. The entire disclosures of all these applications are hereby incorporated by reference.

### TECHNICAL FIELD

The present disclosure relates to a method and an apparatus for providing a guerrilla performance event in a virtual space, and more particularly, to a method and an apparatus for providing a guerrilla performance event in a virtual space, in which an artist holds the guerrilla performance event in the virtual space and provides the guerrilla performance event to users using the virtual space.

### BACKGROUND ART

After the outbreak of COVID-19, the performance industry, which is mainly based on offline activities, suffered a significant impact. Attendance at offline performances has significantly decreased, and consequently, many large theaters, small and medium-sized museums, and art galleries domestically and abroad have successively been forced to close. “Cirque du Soleil” of Canada, which had attracted more than 200 million audience members worldwide for 36 years since its establishment in 1984, filed for bankruptcy protection due to a decrease in revenue caused by COVID-19.

Accordingly, online performances, which had been used as a supplementary means before the outbreak of COVID-19, are emerging as an alternative to offline performances, and cases in which performances are provided through online platforms in a non-face-to-face environment are gradually increasing. From K-POP artists who previously mainly performed offline to the classical label Deutsche Grammophon (DG), performances are shifting to online platforms.

In addition, with the development of XR (extended Reality) technologies for expanding experiences in a virtual space and increasing immersion, such as virtual reality (VR), augmented reality (AR), mixed reality (MR), and holograms, various technologies for performing and viewing artists' performances in virtual reality are being developed and applied.

A performance by Super Junior using XR was viewed by 123,000 people, and ticket [5] revenue alone was expected to reach approximately 6 billion KRW. In addition, a Fortnite concert by Travis Scott recorded 12.3 million concurrent users, demonstrating potential for commercial success, and Wave XR, which is a virtual concert platform, received an investment of 30 million dollars in recognition of its growth potential. These achievements indicate that a demand for XR utilization in the performance industry will increase in the future, and that forms of performance will diversify and develop into a new industry.

However, for performances in the virtual space, there is a problem in that no method has been provided for providing a performance in the virtual space that can further arouse users' interest or enable an artist to perform in a desired manner, beyond merely implementing and providing a performance venue for the artist in the virtual space.

### DISCLOSURE

### Technical Problem

A method and an apparatus for providing a guerrilla performance event in a virtual space according to an embodiment of the present disclosure are directed to generating a guerrilla performance event desired by an artist in the virtual space.

In addition, the method and the apparatus for providing the guerrilla performance event in the virtual space according to the embodiment of the present disclosure are directed to providing the guerrilla performance event performed in the virtual space to fans.

In addition, the method and the apparatus for providing the guerrilla performance event in the virtual space according to the embodiment of the present disclosure are directed to generating and providing a replay of the guerrilla performance event performed in the virtual space.

However, technical objectives of the present embodiment are not limited to the above-described technical objectives, and other technical objectives may exist.

### Technical Solution

As a technical means for achieving the above-described technical objective, according to an embodiment of the present disclosure, there is provided a computer-implemented method for providing a guerrilla performance event in a virtual space, the method comprising, by a processor: setting information related to the guerrilla performance event; generating a guerrilla performance event venue in the virtual space; starting the guerrilla performance event when a number of characters that have entered the guerrilla performance event venue equals or exceeds a predetermined target number of participants; and, when the guerrilla performance event is started, blocking entry of an additional character into the guerrilla performance event venue and providing a streaming video of a performance of an artist to the characters that have entered the guerrilla performance event venue.

Moreover, according to an embodiment of the present disclosure, the setting of the information related to the guerrilla performance event comprises setting a start time of the guerrilla performance event and the target number of participants, and selecting one type from among one or more types of the guerrilla performance event venue.

Moreover, according to an embodiment of the present disclosure, the selecting of the one type from among the one or more types of the guerrilla performance event venue comprises selecting a type of the guerrilla performance event venue for each music unit in the guerrilla performance event, and changing the type of the guerrilla performance event venue to the selected type of the guerrilla performance event venue according to music output from the streaming video of the performance of the artist.

In addition, according to an embodiment of the present disclosure, the providing of the streaming video of the performance of the artist to the characters that have entered the guerrilla performance event venue comprises, when a character among the characters that have entered the guerrilla performance event venue leaves the guerrilla performance event venue, stopping the provision of the streaming video of the performance of the artist to the character that has left the guerrilla performance event venue.

Furthermore, according to an embodiment of the present disclosure, the setting of the information related to the guerrilla performance event further comprises when the setting of the information related to the guerrilla performance event is completed, generating a notice of the guerrilla performance event on at least one of a community platform and a bulletin board related to an artist performing the guerrilla performance event, and generating and providing a notification related to the guerrilla performance event to a user following an artist account.

Moreover, according to an embodiment of the present disclosure, the method further comprises setting an appearance of a character for each music unit in the guerrilla performance event, and changing an appearance of a character attending the guerrilla performance event to the character appearance set for each music unit according to music output from the streaming video of the performance of the artist.

In addition, according to an embodiment of the present disclosure, the method further includes: setting an appearance of a character for each zone unit of the guerrilla performance event venue; acquiring coordinate information of a character attending the guerrilla performance event; classifying a zone in which the character attending the guerrilla performance event is located based on the coordinate information; and changing an appearance of the character attending the guerrilla performance event to the character appearance set for each zone unit based on zone classification information indicating the zone in which the character attending the guerrilla performance event is located.

Furthermore, according to an embodiment of the present disclosure, the method further comprises storing action data of the characters that have entered the guerrilla performance event venue together with action time data, and generating a performance video having a predetermined duration based on a time interval in which a frequency of occurrence of actions of the characters increases or a time interval in which a frequency of occurrence of a predetermined action is highest, and the performance video comprises a video obtained by capturing the guerrilla performance event at a predetermined viewpoint.

Moreover, according to an embodiment of the present disclosure, there is provided an apparatus for providing a guerrilla performance event in a virtual space, the apparatus comprising: a communication module configured to transmit information to and receive information from a terminal; a memory storing at least one instruction; and a processor configured to execute the at least one instruction, in which the processor generates a guerrilla performance event venue in the virtual space, starts the guerrilla performance event when a number of characters that have entered the guerrilla performance event venue equals or exceeds a predetermined target number of participants, and, when the guerrilla performance event is started, blocks entry of an additional character into the guerrilla performance event venue and provides a streaming video of a performance of an artist to the characters that have entered the guerrilla performance event venue.

Moreover, according to an embodiment of the present disclosure, the processor sets a start time of the guerrilla performance event and the target number of participants and selects one type from among one or more types of the guerrilla performance event venue.

In addition, according to an embodiment of the present disclosure, the processor selects a type of the guerrilla performance event venue for each music unit in the guerrilla performance event and changes the type of the guerrilla performance event venue to the selected type of the guerrilla performance event venue for each music unit according to music output from the streaming video of the performance of the artist.

Furthermore, according to an embodiment of the present disclosure, when a character among the characters that have entered the guerrilla performance event venue leaves the guerrilla performance event venue, the processor stops the provision of the streaming video of the performance of the artist to the character that has left the guerrilla performance event venue.

Moreover, according to an embodiment of the present disclosure, when the setting of information related to the guerrilla performance event is completed, the processor generates a notice of the guerrilla performance event on at least one of a community platform and a bulletin board related to an artist performing the guerrilla performance event and generates and provides a notification related to the guerrilla performance event to a user following an artist account.

In addition, according to an embodiment of the present disclosure, the processor sets an appearance of a character for each music unit in the guerrilla performance event and changes an appearance of a character attending the guerrilla performance event to the selected character appearance set for each music unit according to music output from the streaming video of the performance of the artist.

Furthermore, according to an embodiment of the present disclosure, the processor sets an appearance of a character for each zone unit of the guerrilla performance event venue, acquires coordinate information of a character attending the guerrilla performance event, classifies a zone in which the character attending the guerrilla performance event is located based on the coordinate information, and changes an appearance of the character attending the guerrilla performance event to the character appearance set for each zone unit based on zone classification information indicating the zone in which the character attending the guerrilla performance event is located.

In addition, according to an embodiment of the present disclosure, the processor stores action data of the characters that have entered the guerrilla performance event venue together with action time data, generates a performance video having a predetermined duration based on a time interval in which a frequency of occurrence of actions of the characters increases or a time interval in which a frequency of occurrence of a predetermined action is highest, and the performance video comprises a video obtained by capturing the guerrilla performance event at a predetermined viewpoint.

### Advantageous Effects

A method and an apparatus for providing a guerrilla performance event in a virtual space according to an embodiment of the present disclosure can generate a guerrilla performance event desired by an artist in the virtual space.

In addition, the method and the apparatus for providing the guerrilla performance event in the virtual space according to the embodiment of the present disclosure can provide the guerrilla performance event performed in the virtual space to fans.

In addition, the method and the apparatus for providing the guerrilla performance event in the virtual space according to the embodiment of the present disclosure can generate and provide a replay of the guerrilla performance event performed in the virtual space.

### BRIEF DESCRIPTION OF DRAWINGS

FIG. 1 is a conceptual diagram illustrating a method for providing a guerrilla performance event in a virtual space according to an embodiment of the present disclosure.

FIG. 2 is an exemplary diagram illustrating a communication connection between a virtual space guerrilla performance event management server and a terminal according to an embodiment of the present disclosure.

FIG. 3 is a configuration diagram of a management server for the guerrilla performance event in the virtual space according to an embodiment of the present disclosure.

FIG. 4 is a conceptual diagram illustrating functions of the management server for the guerrilla performance event in the virtual space according to an embodiment of the present disclosure.

FIG. 5 is a flowchart illustrating the method for providing the guerrilla performance event in the virtual space according to an embodiment of the present disclosure.

FIG. 6 is a flowchart illustrating a method for providing a replay of the guerrilla performance event in the virtual space according to an embodiment of the present disclosure.

### MODE FOR INVENTION

Hereinafter, embodiments of the present disclosure will be described in detail with reference to the accompanying drawings so that those skilled in the art to which the present disclosure pertains may easily carry out the disclosure. However, the present disclosure may be implemented in various forms and is not limited to the embodiments described herein. In addition, in order to clearly describe the present disclosure in the drawings, parts unrelated to the description are omitted, and similar reference numerals are assigned to similar parts throughout the specification.

Throughout the specification, when a part is referred to as being “connected” to another part, it includes not only a case in which the part is “directly connected”, but also a case in which the part is “electrically connected” with another element interposed therebetween. In addition, when a part is referred to as “including” a component, it means that the part may further include other components rather than excluding other components, unless otherwise specifically stated.

In addition, the accompanying drawings are provided to facilitate understanding of embodiments disclosed in the present specification, and the technical spirit disclosed in the present specification is not limited by the accompanying drawings, and it should be understood that all modifications, equivalents, and substitutes included within the spirit and scope of the present disclosure are included.

Terms including ordinal numbers, such as first and second, may be used to describe various components, but the components are not limited by the terms. The terms are used only for the purpose of classifying one component from another component.

When a component is referred to as being “connected” or “coupled” to another component, it should be understood that the component may be directly connected or coupled to the other component, or another component may be interposed therebetween. On the other hand, when a component is referred to as being “directly connected” or “directly coupled” to another component, it should be understood that no other component is interposed therebetween.

A singular expression includes a plural expression unless the context clearly indicates otherwise.

In the present application, terms such as “include” or “have” are intended to designate the presence of features, numbers, steps, operations, components, parts, or combinations thereof described in the specification, and should not be understood to preclude the presence or addition of one or more other features, numbers, steps, operations, components, parts, or combinations thereof.

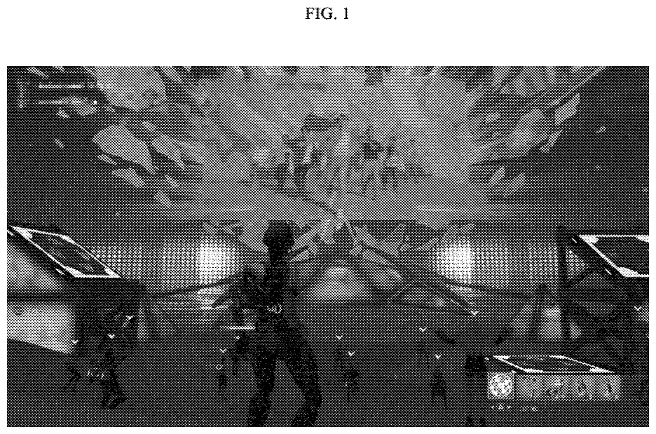

Hereinafter, a method for providing a guerrilla performance event in a virtual space according to an embodiment of the present disclosure will be described with reference to FIG. 1.

FIG. 1 is a conceptual diagram illustrating the method for providing the guerrilla performance event in the virtual space according to the embodiment of the present disclosure.

Referring to FIG. 1, the method (hereinafter referred to as a guerrilla performance event providing method) for providing the guerrilla performance event in the virtual space according to the embodiment of the present disclosure may enable a guerrilla performance to be conducted by holding the guerrilla performance online in a virtual space according to participation of users in the virtual space.

Specifically, the guerrilla performance event providing method enables an artist to perform in the virtual space and generates a guerrilla performance venue so that characters using the virtual space may view the artist's performance. The guerrilla performance may be configured such that a video of the artist or a real-time captured video is played and characters entering the guerrilla performance venue view the video. In addition, the guerrilla performance may be configured such that a central stage structure is generated, the performance is performed using an avatar linked to the artist, and characters entering the guerrilla performance venue view the avatar linked to the artist.

At this time, the guerrilla performance event providing method may set a condition for starting the performance and may start the performance only when the condition is satisfied. In addition, the guerrilla performance event providing method may provide the guerrilla performance only to characters that have entered the guerrilla performance venue at a time of starting the performance, and may restrict entry of characters into the guerrilla performance venue after the start of the performance.

After the performance ends, a user who desires to replay the guerrilla performance event may purchase a replay to re-experience the guerrilla performance event. When the replay of the guerrilla performance event is purchased, a replay performance venue is generated, and the guerrilla performance event may be reproduced as a character of the user enters the replay performance venue.

The replay of the guerrilla performance event reproduces staging of the guerrilla performance event, the guerrilla performance, and actions of audience characters attending a guerrilla performance venue based on data in which the guerrilla performance event is stored in chronological order, so that a user experiencing the replay can obtain an experience corresponding to the time at which the guerrilla performance event was held.

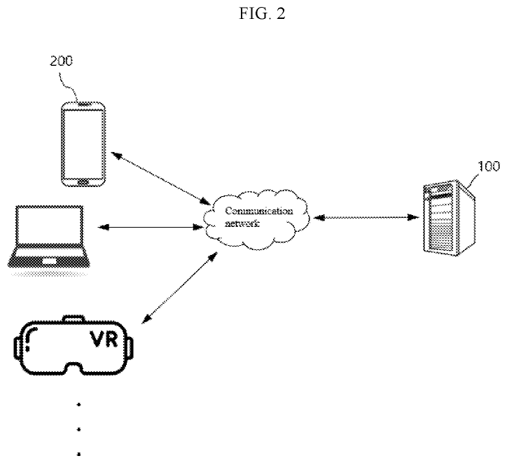

Hereinafter, an interaction between a virtual space guerrilla performance event management server 100 and a terminal 200 according to an embodiment of the present disclosure will be described with reference to FIG. 2.

FIG. 2 is an exemplary diagram illustrating a communication connection between the virtual space guerrilla performance event management server 100 and the terminal 200 according to the embodiment of the present disclosure.

Referring to FIG. 2, the virtual space guerrilla performance event management server 100 and the terminal 200 are communicatively connected through a communication network. In this case, the virtual space guerrilla performance event management server 100 refers to an apparatus that performs data processing related to the guerrilla performance in order to provide the guerrilla performance in the virtual space. The virtual space guerrilla performance event management server 100 may correspond to a server that generates an online virtual space and provides and manages a virtual environment in which characters controlled by users perform actions, such as a metaverse, VR, AR, MR, or XR environment linked with a fan platform.

The virtual space guerrilla performance event management server 100 may generate a virtual space for performing the guerrilla performance of the artist in the virtual space. In addition, the virtual space guerrilla performance event management server 100 may generate characters corresponding to the artist or users using the virtual space, and may perform data processing for implementing actions of the characters in the virtual space by performing data communication with the terminal 200.

In this case, the virtual space guerrilla performance event management server 100 may be implemented not only as a single server but also in a form in which a plurality of servers are interlinked.

The terminal 200 may be classified into a terminal of an artist who intends to perform the guerrilla performance in the virtual space and a terminal of an audience user who intends to view the guerrilla performance in the virtual space.

The terminal 200 may refer to various computing or wireless communication devices, such as a notebook computer, a desktop computer, a laptop computer equipped with a web browser, a smartphone, or a tablet PC.

In addition, the terminal 200 may include various devices for implementing virtual reality or extended reality, such as a VR device, a motion sensing device, a camera device, an audio device, a microphone device, a display device, and a body tracking device.

The communication network illustrated in FIG. 2 may be implemented as a wired network, such as a local area network (LAN), a wide area network (WAN), or a value added network (VAN), or as a wireless network, such as a mobile radio communication network, a satellite communication network, Bluetooth, near field communication (NFC), or a 5G communication network.

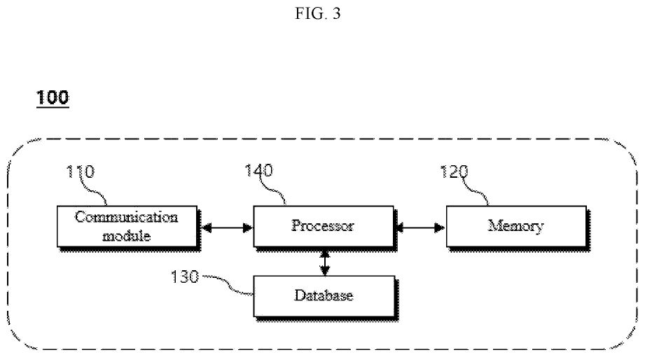

Hereinafter, a structure of the virtual space guerrilla performance event management server according to the embodiment of the present disclosure will be described with reference to FIG. 3.

FIG. 3 is a diagram illustrating a structure of the virtual space guerrilla performance event management server 100 according to the embodiment of the present disclosure.

Referring to FIG. 3, the virtual space guerrilla performance event management server 100 includes a communication module 110, a memory 120, and a processor 140, and may further include a database 130. The communication module 110 performs transmission and reception of information with a terminal 200. The communication module 110 may include an apparatus including hardware and software required for transmitting and receiving signals, such as a control signal or a data signal, by using a wired or wireless connection with another network device.

The memory 120 stores a virtual space guerrilla performance event management program and/or instructions for performing management of a virtual space guerrilla performance event. A name of the virtual space guerrilla performance event management program is set for convenience of description and does not limit a function of the program itself.

The memory 120 may store at least one of information and data input to the communication module 110, information and data required for functions performed by the processor 140, and data generated by execution of the processor 140.

The memory 120 should be interpreted as including both a non-volatile storage device that continuously maintains stored information even when power is not supplied and a volatile storage device that requires power to maintain stored information. In addition, the memory 120 may perform a function of temporarily or permanently storing data processed by the processor 140. The memory 120 may include a magnetic storage medium or a flash storage medium in addition to the volatile storage device requiring power to maintain stored information, but the scope of the present disclosure is not limited thereto.

The database 130 may store data related to generation and provision of the virtual space guerrilla performance event. The database 130 may constitute a part of the memory 120, but is not necessarily located inside the virtual space guerrilla performance event management server 100, and may be connected outside the virtual space guerrilla performance event management server 100 to perform transmission and reception of data through a communication connection.

In addition, the database 130 may store data related to the virtual space guerrilla performance event, such as the staging of the guerrilla performance event and stage effects, in chronological order. In addition, the database 130 may store action logs of audience characters participating in the guerrilla performance event in chronological order as shown in Table 1.

TABLE 1

| Character | | | | | | |
|---|---|---|---|---|---|---|
| ID | Time | Input key | Action | Position x | Position y | Position z |
| 1001 | 2024 Nov. 1 | Move left | Down | 0.013 | −3.243 | 0.234 |
| | 19:01:22.000 | | | | | |
| 1001 | 2024 Nov. 1 | Move left | Up | 0.113 | −3.243 | 0.234 |
| | 19:01:23.000 | | | | | |
| 1002 | 2024 Nov. 1 | Jump | Down | 1.234 | 3.458 | 10.349 |
| | 19:01:23.000 | | | | | |
| 1002 | 2024 Nov. 1 | Jump | Up | 1.234 | 13.458 | 10.349 |
| | 19:01:24.000 | | | | | |
| 1001 | 2024 Nov. 1 | Greeting | Down | 0.113 | −3.243 | 0.234 |
| | 19:01:27.000 | | | | | |
| 1001 | 2024 Nov. 1 | Greeting | Up | 0.113 | −3.243 | 0.234 |
| | 19:01:29.000 | | | | | |
| 1001 | 2024 Nov. 1 | Dancing | Down | 0.113 | −3.243 | 0.234 |
| | 19:01:30.000 | | | | | |
| 1001 | 2024 Nov. 1 | Cheering | Down | 0.113 | −3.243 | 0.234 |
| | 19:01:31.000 | | | | | |
| 1002 | 2024 Nov. 1 | Greeting | Down | 1.234 | 3.458 | 10.349 |
| | 19:01:31.000 | | | | | |
| 1001 | 2024 Nov. 1 | Cheering | Up | 0.113 | −3.243 | 0.234 |
| | 19:01:32.000 | | | | | |
| 1002 | 2024 Nov. 1 | Greeting | Up | 1.234 | 3.458 | 10.349 |
| | 19:01:33.000 | | | | | |
| 1001 | 2024 Nov. 1 | Dancing | Up | 0.113 | −3.243 | 0.234 |
| | 19:01:35.000 | | | | | |

Table 1 is a log data storage table of audience characters participating in the guerrilla performance event. The database generates log data regarding actions of audience characters that attend each guerrilla performance on a per-guerrilla-performance-event basis. In this case, as shown in Table 1, log data may be generated and stored for each character ID, and a time at which an action of each character occurs, an input key during the operation, a character action corresponding to the input key, and position coordinate values (x, y, and z coordinate values) may be stored in a table format.

As described above, data regarding performance of the guerrilla performance event and actions of participating audience characters may be stored together with time information.

The processor 140 is configured to execute the virtual space guerrilla performance event management program and/or instructions stored in the memory 120. The processor 140 may include various types of devices for controlling and processing data.

The processor 140 may refer to a data processing device embedded in hardware and having a physically structured circuit for performing functions expressed as code or instructions included in the program. In one example, the processor 140 may be implemented in a form of a microprocessor, a central processing unit (CPU), a processor core, a multiprocessor, an application-specific integrated circuit (ASIC), or a field programmable gate array (FPGA), but the scope of the present disclosure is not limited thereto.

The processor 140 is configured to execute the virtual space guerrilla performance event management program or instructions to perform the following functions and procedures.

The processor 140 may generate a guerrilla performance event venue in the virtual space and may start a performance of the guerrilla performance event when the number of characters entering the guerrilla performance event venue is equal to or greater than a preset target number.

The processor 140 may block entry of new characters when the guerrilla performance event starts and may provide a streaming video of an artist performance to characters that have entered the guerrilla performance event venue.

In addition, the processor 140 may set a start time of the guerrilla performance event and a target number of participants for holding the performance and may generate the guerrilla performance event by selecting one of one or more types of the guerrilla performance event venue.

In addition, the processor 140 may select a type of the guerrilla performance event venue for each music unit of the guerrilla performance event. The processor 140 may change the type of the guerrilla performance event venue according to music output from a streaming video of the artist performance in the guerrilla performance event.

In addition, when a character entering the guerrilla performance event venue leaves the guerrilla performance event venue, the processor 140 may stop providing the streaming video of the artist performance to the character that has left the venue.

When setting of information related to the guerrilla performance event is completed, the processor 140 may generate a notice of the guerrilla performance event on a community platform or a bulletin board related to an artist performing the guerrilla performance event. In addition, the processor 140 may generate and provide a notification related to the guerrilla performance event to users or characters following an artist account performing the guerrilla performance event.

In addition, the processor 140 may set an appearance of a character for each music unit of the guerrilla performance event. Accordingly, the processor 140 may change the appearance of an audience character attending the guerrilla performance event to a character appearance set for a selected music unit according to music output from a streaming video of an artist performance in the guerrilla performance event.

In addition, the processor 140 may set an appearance of a character based on a zone unit or coordinates of the guerrilla performance event venue. The processor 140 acquires coordinate information of a character attending the guerrilla performance event and classifies a zone in which an audience character attending the guerrilla performance event is located based on the coordinate information. In addition, the processor 140 may change the appearance of the audience character attending the guerrilla performance event to a character appearance set for each zone unit based on zone classification information indicating the zone in which the character attending the guerrilla performance event is located.

In addition, the processor 140 may generate a performance video having a preset time length based on action data of audience characters stored in the database 130, specifically based on a time interval in which a frequency of occurrence of actions of the audience characters increases or a time interval in which a frequency of occurrence of a preset action is highest. In this case, the performance video may include a streaming video of the artist performance and videos of characters entering the guerrilla performance event venue, or may mean a video obtained by capturing the guerrilla performance event at a preset viewpoint.

In addition, the processor 140 may perform the following functions in order to provide a replay of the guerrilla performance event.

When a guerrilla performance occurs in the virtual space, the processor 140 stores guerrilla performance data regarding at least one of appearances of audience characters attending the guerrilla performance, behaviors of the audience characters, a guerrilla performance venue, staging of the guerrilla performance, and an artist performance video in the database 130. When the guerrilla performance ends, the processor 140 provides a replay function for the guerrilla performance and may reproduce and provide the guerrilla performance and audience characters attending the guerrilla performance event based on the stored guerrilla performance data to a character using the replay function.

In addition, the processor 140 may store data regarding the appearances of audience characters attending the guerrilla performance, the behaviors of the audience characters, the guerrilla performance venue, the staging of the guerrilla performance, and the artist performance video in chronological order.

In addition, the processor 140 may generate a replay performance venue in which the replay function of the guerrilla performance event is provided, and may provide the replay function to a character entering the replay performance venue when the character enters the replay performance venue.

In addition, the processor 140 may reproduce a type of the guerrilla performance venue, the staging of the guerrilla performance, the artist performance video, and appearances and actions of audience characters attending the guerrilla performance based on the guerrilla performance data stored in chronological order. Accordingly, the processor 140 may provide an interaction between a character entering the replay performance venue and at least one of the reproduced staging of the guerrilla performance and reproduced audience characters.

In addition, the processor 140 may provide a function for writing a review of the guerrilla performance or a function for entering a rating to a character in the replay performance venue until a time point at which the replay of the guerrilla performance is completed.

In addition, the processor 140 may select a type of the replay performance venue for each music unit of the guerrilla performance and may change the selected type of the replay performance venue according to music output from the streaming video of the artist performance.

In addition, the processor 140 may set an appearance of a character for each zone unit of the replay performance venue. The processor 140 acquires coordinate information of a character attending the replay performance venue and classifies a zone in which the character attending the replay performance venue is located based on the coordinate information. Moreover, the processor 140 may change the appearance of the character attending the replay performance venue to the character appearance set for each zone unit based on the zone classification information indicating a zone in which the character attending the replay performance venue is located.

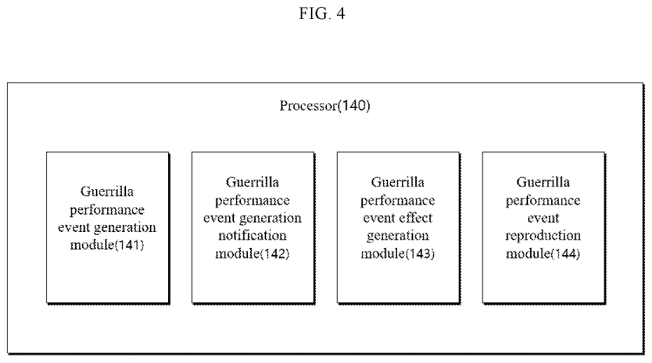

Hereinafter, functions of the guerrilla performance event management server will be described in detail with reference to FIG. 4.

FIG. 4 is a conceptual diagram illustrating functions of the guerrilla performance event management server according to an embodiment of the present disclosure.

Referring to FIG. 4, the guerrilla performance event management server 100 includes a guerrilla performance event generation module 141, a guerrilla performance event generation notification module 142, a guerrilla performance event effect generation module 143, and a guerrilla performance event reproduction module 144.

The guerrilla performance event generation module 141 sets basic information for generating a guerrilla performance, such as a guerrilla performance start time, a guerrilla performance venue generation location, a guerrilla performance venue type, and a target audience size (target number of participants) for the guerrilla performance, according to settings of an artist account, and generates a guerrilla performance event according to the basic setting information.

The artist may select one of a real-time video streaming method, an artist video streaming method, and a performance method using an artist character during the guerrilla performance, and the guerrilla performance event generation module 141 executes the guerrilla performance according to the selected performance method.

In addition, the guerrilla performance event generation module 141 acquires location information of characters in the virtual space and may classify an audience character entering the guerrilla performance venue from a character not entering the guerrilla performance venue based on location information of the characters and zone or coordinate information of the guerrilla performance venue. Further, the guerrilla performance event generation module 141 may count and display the number of audience characters entering the guerrilla performance venue, and may start the guerrilla performance when the number of audience characters entering the guerrilla performance venue reaches a target audience size (target number of participants) for the guerrilla performance.

In addition, the guerrilla performance event generation module 141 may acquire location information of an audience character attending the guerrilla performance venue during the guerrilla performance, and when the audience character leaves the guerrilla performance venue, may stop providing the artist performance video to the character that has left the guerrilla performance venue.

The guerrilla performance event generation notification module 142 provides a notification of the generation of the guerrilla performance event to a user who has requested receipt of a notification regarding the guerrilla performance event when the guerrilla performance event is generated.

Specifically, the guerrilla performance event generation notification module 142 may generate a notice of the guerrilla performance event on a community platform or a bulletin board related to an artist performing the guerrilla performance event. In addition, the guerrilla performance event generation notification module 142 may generate and provide a notification related to the guerrilla performance event to a user following the artist account.

The guerrilla performance event effect generation module 143 generates settings related to special effects and staging of the guerrilla performance, such as stage effects occurring in the guerrilla performance, performance staging, and changes in character appearance, and generates special effects and staging according to the settings.

Specifically, the guerrilla performance event effect generation module 143 may set different types of the guerrilla performance event venue for each music unit of the guerrilla performance. Accordingly, the guerrilla performance event effect generation module 143 may change the type of the guerrilla performance event venue to a type of the guerrilla performance event venue selected for each music unit according to music output from the streaming video of the artist performance.

In addition, the guerrilla performance event effect generation module 143 may set the appearance of a character for each music unit and may change the appearance of a character attending the guerrilla performance event to the character appearance selected for each music unit according to music output from the streaming video of the artist performance.

In addition, the guerrilla performance event effect generation module 143 may set the appearance of a character based on a zone unit or coordinates of the guerrilla performance event venue. In this case, the guerrilla performance event effect generation module 143 acquires coordinate information of the audience character attending the guerrilla performance event and classifies a zone in which the audience character attending the guerrilla performance event is located based on the coordinate information. Further, the guerrilla performance event effect generation module 143 may change the appearance of the audience character attending the guerrilla performance event to the character appearance set for each zone unit based on the zone classification information indicating a zone in which the character attending the guerrilla performance event is located.

In addition, the guerrilla performance event effect generation module 143 may perform settings and implementation of various stage production and special effects, such as a lighting effect and a fireworks effect.

In addition, the guerrilla performance event effect generation module 143 may provide a viewpoint switching function for an audience character based on a viewpoint set by the artist or the administrator in order to view the guerrilla performance event.

Specifically, an artist or an administrator may set one or more viewpoints from which the audience character can view a guerrilla performance event or one or more viewpoints for capturing the guerrilla performance event.

Accordingly, although the guerrilla performance event is basically displayed from a first-person viewpoint of the audience character, the guerrilla performance event may be displayed by changing to various viewpoints according to the selected viewpoint.

In addition, when a video regarding the guerrilla performance event is generated, a video obtained by recording the guerrilla performance event from not only the first-person viewpoint of the audience character but also a plurality of viewpoints may be generated.

The guerrilla performance event reproduction module 144 performs functions for generating data for providing the replay of the guerrilla performance event and for generating the replay.

The guerrilla performance event reproduction module 144 stores data from a start of the guerrilla performance event to an end thereof in the database in chronological order. Further, the guerrilla performance event reproduction module 144 may provide the replay by reproducing staging, effects, and actions of the audience character in the performance venue based on the data stored in chronological order. Accordingly, the user performing the replay can experience interaction with characters, staging, and effects as if directly participating in the guerrilla performance event, rather than merely viewing the artist performance as the video in the virtual space.

Specifically, the guerrilla performance event reproduction module 144 may store data related to the virtual space guerrilla performance event, such as the staging of the performance and stage effects of the guerrilla performance event, in chronological order. In addition, the database 130 may store action logs for each audience character participating in the guerrilla performance event in chronological order as shown in Table 1 described above.

Accordingly, the guerrilla performance event reproduction module 144 may generate and store log data for each character ID with respect to an action of the audience character attending the guerrilla performance, and may store, in a table format, a time at which an action of each character occurs, an input key during the operation, a character action corresponding to the input key, and position coordinate values (x, y, and z coordinate values).

When a user purchases or executes the replay function of the guerrilla performance event, the guerrilla performance event reproduction module 144 generates a replay performance venue for providing the replay function of the guerrilla performance event. That is, the guerrilla performance event reproduction module 144 generates, in the virtual space, a performance venue into which only a character able to use the replay function is able to enter. In this case, the replay performance venue may be generated in substantially the same form as the performance venue of the guerrilla performance event.

The guerrilla performance event reproduction module 144 reproduces the guerrilla performance from a time point at which a character able to use the replay function enters the replay performance venue. That is, the guerrilla performance event reproduction module 144 reads chronological log data from a start time point of the guerrilla performance to an end time point thereof from the database 130, and reproduces staging, effects, and actions of the audience character in the performance venue from the start time point of the guerrilla performance to the end time point thereof based on the chronological log data.

Further, a character entering the replay performance venue may interact with the staging, effects, and audience characters of the reproduced performance in the reproduced guerrilla performance. Accordingly, the appearance of the character entering the replay performance venue may also be changed according to music or a zone, and the character may perform actions implemented in the virtual space, including moving, cheering, and jumping.

In addition, although the guerrilla performance event is basically displayed from a first-person viewpoint of the audience character for a character entering the replay performance venue, the guerrilla performance event may be displayed by changing to various viewpoints according to a selected viewpoint.

When the character entering the replay performance venue leaves the replay performance venue, the guerrilla performance event reproduction module 144 may stop providing the artist performance video to the character after the character leaves.

In addition, the guerrilla performance event reproduction module 144 may provide a function for writing a review of the guerrilla performance or a function for entering a rating to a character attending the replay performance venue until a time point at which the replay of the guerrilla performance is completed.

Additionally, the guerrilla performance event reproduction module 144 may automatically generate a replay video having a short duration based on a degree of reaction of audience characters during the guerrilla performance.

Specifically, the guerrilla performance event reproduction module 144 may generate a performance video having a preset time length based on a time interval in which a frequency of occurrence of actions of the audience characters increases or a time interval in which a frequency of occurrence of a preset action, such as waving a right hand or assuming a specific pose, is highest, based on chronological action data of the audience characters stored in the database 130.

At this time, the generated performance video is generated to have the preset time length so as to be usable for TikTok, YouTube Shorts, and the like, and may mean a recorded video of the guerrilla performance event recorded from a viewpointset by at least one of the artist, an administrator, and a user.

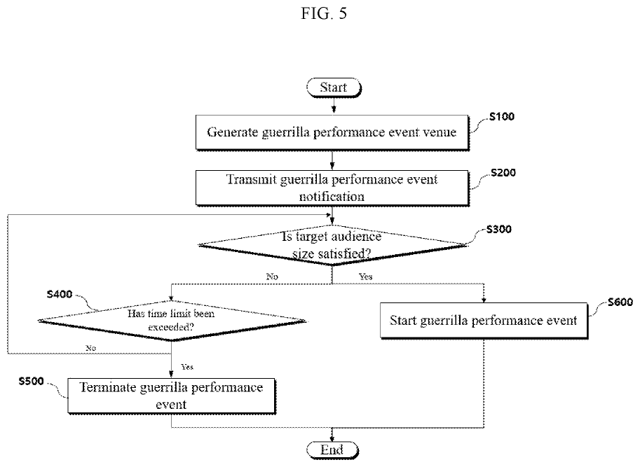

Hereinafter, the method for providing the guerrilla performance event in the virtual space according to an embodiment of the present disclosure will be described with reference to FIG. 5.

FIG. 5 is a flowchart illustrating the method for providing the guerrilla performance event in the virtual space according to the embodiment of the present disclosure.

Referring to FIG. 5, the method for providing the guerrilla performance event in the virtual space includes a guerrilla performance event venue generation step (S100), a guerrilla performance event notification transmission step (S200), and a target audience size satisfaction determination step (S300).

In the guerrilla performance event venue generation step (S100), the virtual space guerrilla performance event management server 100 generates a venue for performing the guerrilla performance in the virtual space according to settings of the artist or the administrator.

The guerrilla performance event venue generation step (S100) may include a step of setting a start time of the guerrilla performance event and a target number of participants for starting the guerrilla performance event, and a step of selecting one of one or more types of the guerrilla performance event venue.

In the guerrilla performance event venue generation step (S100), the artist or the administrator may set, as basic setting information for the guerrilla performance, a start time of the guerrilla performance event, a generation location (zone) of the guerrilla performance venue, a type of the guerrilla performance venue, and a target number of participants (target audience size) for starting the guerrilla performance event.

At this time, the artist or the administrator may select a type and a size of the guerrilla performance venue by selecting one of preset types of the guerrilla performance venue. In addition, when the artist or the administrator selects one of the types of the guerrilla performance venue, the virtual space guerrilla performance event management server 100 generates a virtual image corresponding to the selected type and size of the guerrilla performance venue in the virtual space.

The artist and the administrator may set a placement location or a placement zone of the guerrilla performance venue by using a method of placing the generated virtual image at a specific location or zone in the virtual space or a method of setting position coordinates.

In the guerrilla performance event venue generation step (S100), the virtual space guerrilla performance event management server 100 may generate the guerrilla performance venue in the virtual space based on information set by the artist or the administrator.

In the guerrilla performance event notification transmission step (S200), the virtual space guerrilla performance event management server 100 may transmit a notification to a user who has permitted receipt of a notification regarding the guerrilla performance, or may generate a post regarding the guerrilla performance on a bulletin board related to the artist.

The guerrilla performance event notification transmission step (S200) may include generating a notice of the guerrilla performance event on a community platform or a bulletin board related to an artist performing the guerrilla performance event, and generating and providing a notification related to the guerrilla performance event to users following an artist account, by the virtual space guerrilla performance event management server 100.

In addition, in the guerrilla performance event notification transmission step (S200), instead of transmitting the notification to users or generating the post, promotional materials or advertising materials regarding the guerrilla performance in the virtual space may be generated.

In the target audience size satisfaction determination step (S300), the virtual space guerrilla performance event management server 100 acquires position coordinate information of characters in the virtual space and determines an audience character that has entered (is located inside) the guerrilla performance venue by using the position coordinate information of the characters.

Further, in the target audience size satisfaction determination step (S300), when the number of audience characters does not reach the preset target number of participants (target audience size), the virtual space guerrilla performance event management server 100 does not start the guerrilla performance and displays a current number of audience characters that have entered the guerrilla performance venue.

At this time, a method of displaying the current number of audience characters that have entered the guerrilla performance venue may be implemented by displaying the current audience size on a screen included in the guerrilla performance venue or by providing current audience size information to audience characters that have currently entered the guerrilla performance venue.

In a time limit exceeded determination step (S400), when the target audience size is not satisfied, the virtual space guerrilla performance event management server 100 determines whether a time limit set by the artist or administrator account has been exceeded. When the time limit has not been exceeded, the target audience size satisfaction determination step (S300) is performed again, and when the time limit has been exceeded, a guerrilla performance event extinction step (S500) is performed.

In the guerrilla performance event extinction step (S500), when it is determined that the target audience size has not been satisfied within a preset time, the guerrilla performance is not started, and the guerrilla performance event is terminated.

In the target audience size satisfaction determination step (S300), when the target audience size is satisfied, a guerrilla performance event start step (S600) is performed.

In the guerrilla performance event start step (S600), the virtual space guerrilla performance event management server 100 blocks entry of a new character into the guerrilla performance event venue. In addition, in the guerrilla performance event start step (S600), the virtual space guerrilla performance event management server 100 provides a streaming video of the artist performance to the character that has entered the guerrilla performance event venue.

In addition, in the guerrilla performance event start step (S600), when the character that has entered the guerrilla performance event venue leaves the guerrilla performance event venue, the virtual space guerrilla performance event management server 100 may stop providing the streaming video of the artist performance to the character that has left the guerrilla performance event venue.

At this time, the artist performance video may be a real-time video or a recorded video. In addition to a method of displaying the artist performance video on a screen of the virtual guerrilla performance venue, a method in which the artist performs the performance using a character by using various devices for implementing virtual reality or extended reality, such as a body tracking device, may be applied.

In addition, in the guerrilla performance event start step (S600), the virtual space guerrilla performance event management server 100 may generate and apply various stage effects according to settings of the artist or the administrator.

The artist account or the administrator account may set different types of the guerrilla performance event venue for each music unit of the guerrilla performance. Accordingly, in the guerrilla performance event start step (S600), the virtual space guerrilla performance event management server 100 may change a type of the guerrilla performance event venue to a preset type of the guerrilla performance event venue according to music output from a streaming video of the artist performance.

In addition, the artist account or the administrator account may set an appearance of a character for each music unit. Accordingly, in the guerrilla performance event start step (S600), the virtual space guerrilla performance event management server 100 may change an appearance of a character attending the guerrilla performance event to the selected character appearance for each music unit according to music output from the streaming video of the artist performance.

In addition, the artist account or the administrator account may set an appearance of a character for each zone unit of the guerrilla performance event venue. Accordingly, in the guerrilla performance event start step (S600), the virtual space guerrilla performance event management server 100 may change an appearance of the character for each zone of the venue by performing a step of acquiring coordinate information of a character attending the guerrilla performance event, a step of classifying a zone in which the character attending the guerrilla performance event is located based on the coordinate information, and a step of changing an appearance of the character attending the guerrilla performance event to the character appearance set for each zone unit based on zone classification information indicating the zone in which the character attending the guerrilla performance event is located.

In addition, in the guerrilla performance event start step (S600), the guerrilla performance event effect generation module 143 may provide a viewpoint switching function of an audience character based on a viewpoint set by the artist or the administrator in order to view the guerrilla performance event.

Specifically, the artist or the administrator may set one or more viewpoints from which the audience character is able to view the guerrilla performance event or one or more viewpoints for capturing the guerrilla performance event, and thereby providing an effect of viewing the guerrilla performance event from various viewpoints.

Additionally, in the guerrilla performance event start step (S600), the processor 140 may automatically generate a replay video having a short duration based on a degree of reaction of audience characters during the guerrilla performance.

For example, the processor 140 may generate a performance video having a preset time length based on a time interval in which a frequency of occurrence of actions of the audience characters increases or a time interval in which a frequency of occurrence of a preset action, such as waving a right hand or assuming a specific pose, is highest, based on chronological action data of the audience characters stored in the database 130.

At this time, the generated performance video is generated to have the preset time length so as to be usable for TikTok, YouTube Shorts, and the like, and may mean a recorded video of the guerrilla performance event recorded from a viewpoint set by at least one of the artist, an administrator, and a user.

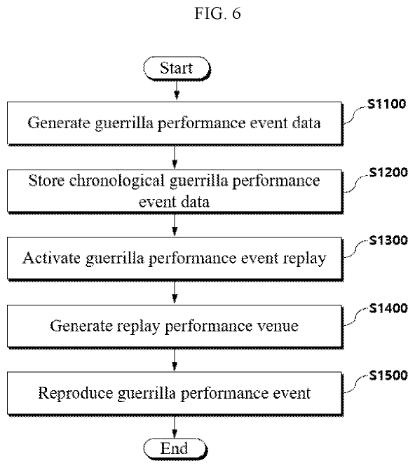

Hereinafter, a method for providing a replay of the guerrilla performance event in the virtual space according to an embodiment of the present disclosure will be described with reference to FIG. 6.

FIG. 6 is a flowchart illustrating the method for providing the replay of the guerrilla performance event in the virtual space according to the embodiment of the present disclosure.

Referring to FIG. 6, the method for providing the replay of the guerrilla performance event in the virtual space includes a guerrilla performance event data generation step (S1100), a chronological guerrilla performance event data storage step (S1200), a guerrilla performance event replay activation step (S1300), a replay performance venue generation step (S1400), and a guerrilla performance event reproduction step (S1500).

In the guerrilla performance event data generation step (S1100), the virtual space guerrilla performance event management server 100 generates data for generating the replay of the guerrilla performance event, such as appearances of audience characters, behaviors of the audience characters, a type of the guerrilla performance venue, performance staging, and an artist performance video, from a start time point of the guerrilla performance event to an end time point thereof.

In the chronological guerrilla performance event data storage step (S1200), the virtual space guerrilla performance event management server 100 stores data for generating the replay of the guerrilla performance event in the database 130 in chronological order. In this case, as described above with reference to Table 1, log data may be generated and stored for each character ID, and a time at which an action of each character occurs, an input key during the operation, a character action corresponding to the input key, and position coordinate values (x, y, and z coordinate values) may be stored in a table format.

In the guerrilla performance event replay activation step (S1300), the virtual space guerrilla performance event management server 100 activates a guerrilla performance replay function for a user or a character that has purchased the replay function or a user or a character that has been granted replay authority.

When the guerrilla performance replay function is executed, the virtual space guerrilla performance event management server 100 generates a replay performance venue in the replay performance venue generation step (S1400). Further, when a character enters the replay performance venue, the virtual space guerrilla performance event management server 100 provides the replay function to the character entering the replay performance venue.

The replay performance venue allows a user or a character that has purchased the replay function or a user or a character that has been granted replay authority to enter and re-experience performance staging, the artist performance, and actions of the audience characters during the guerrilla performance.

In the guerrilla performance event reproduction step (S1500), the virtual space guerrilla performance event management server 100 may reproduce a type of the guerrilla performance venue, staging of the guerrilla performance, the artist performance video, and appearances and actions of audience characters attending the guerrilla performance based on guerrilla performance data stored in chronological order. Accordingly, the virtual space guerrilla performance event management server 100 may provide an interaction between a character entering the replay performance venue and at least one of the reproduced guerrilla performance staging and reproduced audience characters.

In addition, in the guerrilla performance event reproduction step (S1500), the virtual space guerrilla performance event management server 100 may provide a function for writing a review of the guerrilla performance or a function for entering a rating to a character attending the replay performance venue until a time point at which the replay of the guerrilla performance is completed.

In addition, in the guerrilla performance event reproduction step (S1500), the virtual space guerrilla performance event management server 100 may apply various stage effects and staging performed in the above-described guerrilla performance event start step (S600) to a character using the replay function.

Accordingly, also in the guerrilla performance event reproduction step (S1500), the virtual space guerrilla performance event management server 100 may change the type of the guerrilla performance event venue to the preset type of the guerrilla performance event venue according to music output from the streaming video of the artist performance.

In addition, also in the guerrilla performance event reproduction step (S1500), the artist account or the administrator account may set the appearance of the character for each music unit. Accordingly, in the guerrilla performance event reproduction step (S1500), the virtual space guerrilla performance event management server 100 may perform a step of changing the appearance of the character attending the replay performance venue to the selected character appearance for each music unit according to music output from the streaming video of the artist performance.

In addition, also in the guerrilla performance event reproduction step (S1500), the artist account or the administrator account may set the appearance of the character for each zone of the replay performance venue. Accordingly, in the guerrilla performance event reproduction step (S1500), the virtual space guerrilla performance event management server 100 may change the appearance of the character for each zone of the venue by performing a step of acquiring coordinate information of a character attending the replay performance venue, a step of classifying a zone in which the character attending the replay performance venue is located based on the coordinate information, and a step of changing the appearance of the character attending the replay performance venue to the character appearance set for each zone unit based on the zone classification information indicating the zone in which the character attending the replay performance venue is located.

The above description of the present disclosure is for illustrative purposes, and those skilled in the art to which the present disclosure pertains will understand that the present disclosure may be easily modified into other specific forms without changing the technical spirit or essential features of the present disclosure. Therefore, it should be understood that the embodiments described above are illustrative in all respects and not restrictive. For example, each component described as being in a single form may be implemented in a distributed manner, and likewise, components described as being distributed may also be implemented in a combined form.

The scope of the present disclosure is indicated by the claims to be described below rather than by the detailed description above, and all changes or modified forms derived from meanings and scopes of the claims and equivalent concepts thereof should be construed as being included in the scope of the present disclosure.

### INDUSTRIAL APPLICABILITY

The present disclosure relates to a method and an apparatus for providing a guerrilla performance event in a virtual space and is applicable to an entertainment-related industry, and thus has industrial applicability.

1. A computer-implemented method for providing a guerrilla performance event in a virtual space, the method comprising:
setting, by a processor, information related to the guerrilla performance event;
generating, by the processor, a guerrilla performance event venue in the virtual space;
starting, by a processor, the guerrilla performance event when a number of characters that have entered the guerrilla performance event venue equals or exceeds a predetermined target number of participants; and
when the guerrilla performance event is started, blocking entry of an additional character into the guerrilla performance event venue and providing a streaming video of a performance of an artist to the characters that have entered the guerrilla performance event venue.

2. The method of claim 1, wherein the setting of the information related to the guerrilla performance event comprises:
setting a start time of the guerrilla performance event and the target number of participants, and
selecting one type from among one or more types of the guerrilla performance event venue.

3. The method of claim 2, wherein the selecting of the one type from among the one or more types of the guerrilla performance event venue comprises:
selecting a type of the guerrilla performance event venue for each music unit in the guerrilla performance event, and
changing the type of the guerrilla performance event venue to the selected type of the guerrilla performance event venue according to music output from the streaming video of the performance of the artist.

4. The method of claim 3, wherein the providing of the streaming video of the performance of the artist to the characters that have entered the guerrilla performance event venue comprises:
when a character among the characters that have entered the guerrilla performance event venue leaves the guerrilla performance event venue, stopping the provision of the streaming video of the performance of the artist to the character that has left the guerrilla performance event venue.

5. The method of claim 1, wherein the setting of the information related to the guerrilla performance event further comprises:
when the setting of the information related to the guerrilla performance event is completed, generating a notice of the guerrilla performance event on at least one of a community platform and a bulletin board related to an artist performing the guerrilla performance event, and
generating and providing a notification related to the guerrilla performance event to a user following an artist account.

6. The method of claim 1, further comprising:
setting an appearance of a character for each music unit in the guerrilla performance event, and
changing an appearance of a character attending the guerrilla performance event to the character appearance set for each music unit according to music output from the streaming video of the performance of the artist.

7. The method of claim 6, further comprising:
setting an appearance of a character for each zone unit of the guerrilla performance event venue;
acquiring coordinate information of a character attending the guerrilla performance event;
classifying a zone in which the character attending the guerrilla performance event is located based on the coordinate information; and
changing an appearance of the character attending the guerrilla performance event to the character appearance set for each zone unit based on zone classification information indicating the zone in which the character attending the guerrilla performance event is located.

8. The method of claim 1, further comprising:
storing action data of the characters that have entered the guerrilla performance event venue together with action time data; and
generating a performance video having a predetermined duration based on a time interval in which a frequency of occurrence of actions of the characters increases or a time interval in which a frequency of occurrence of a predetermined action is highest,
wherein the performance video comprises a video obtained by capturing the guerrilla performance event at a predetermined viewpoint.

9. An apparatus for providing a guerrilla performance event in a virtual space, the apparatus comprising:
a communication module configured to transmit information to and receive information from a terminal;
a memory storing at least one instruction; and
a processor configured to execute the at least one instruction,
wherein the processor is configured to generate a guerrilla performance event venue in the virtual space, start the guerrilla performance event when a number of characters that have entered the guerrilla performance event venue equals or exceeds a predetermined target number of participants, and, when the guerrilla performance event is started, block entry of an additional character into the guerrilla performance event venue and provide a streaming video of a performance of an artist to the characters that have entered the guerrilla performance event venue.

10. The apparatus of claim 9, wherein the processor is configured to set a start time of the guerrilla performance event and the target number of participants and select one type from among one or more types of the guerrilla performance event venue.

11. The apparatus of claim 10, wherein the processor is configured to select a type of the guerrilla performance event venue for each music unit in the guerrilla performance event and change the type of the guerrilla performance event venue to the selected type of the guerrilla performance event venue for each music unit according to music output from the streaming video of the performance of the artist.

12. The apparatus of claim 11, wherein, when a character among the characters that have entered the guerrilla performance event venue leaves the guerrilla performance event venue, the processor is configured to stop the provision of the streaming video of the performance of the artist to the character that has left the guerrilla performance event venue.

13. The apparatus of claim 12, wherein, when the setting of information related to the guerrilla performance event is completed, the processor is configured to generate a notice of the guerrilla performance event on at least one of a community platform and a bulletin board related to an artist performing the guerrilla performance event and generate and provide a notification related to the guerrilla performance event to a user following an artist account.

14. The apparatus of claim 13, wherein the processor is configured to set an appearance of a character for each music unit in the guerrilla performance event and change an appearance of a character attending the guerrilla performance event to the character appearance set for each music unit according to music output from the streaming video of the performance of the artist.

15. The apparatus of claim 14, wherein the processor is configured to set an appearance of a character for each zone unit of the guerrilla performance event venue, acquire coordinate information of a character attending the guerrilla performance event, classify a zone in which the character attending the guerrilla performance event is located based on the coordinate information, and change an appearance of the character attending the guerrilla performance event to the character appearance set for each zone unit based on zone classification information indicating the zone in which the character attending the guerrilla performance event is located.

16. The apparatus of claim 15, wherein the processor is configured to store action data of the characters that have entered the guerrilla performance event venue together with action time data, generate a performance video having a predetermined duration based on a time interval in which a frequency of occurrence of actions of the characters increases or a time interval in which a frequency of occurrence of a predetermined action is highest, wherein, the performance video comprises a video obtained by capturing the guerrilla performance event at a predetermined viewpoint.
